(19) United States
(12) Patent Application Publication
(10) Pub. No.: US 2023/0205782 A1
(43) Pub. Date: Jun. 29, 2023

(54) Method For Managing Database

(71) Applicant: TmaxTibero Co., Ltd., Gyeonggi-do (KR)

(72) Inventors: Kunwoo PARK, Seoul (KR); Taeseop KIM, Gyeonggi-do (KR); Taehyun KIM, Gyeonggi-do (KR); Yongkwon KIM, Gyeonggi-do (KR); Joohyun LEE, Gyeonggi-do (KR); Sangyoung PARK, Seoul (KR)

(73) Assignee: TmaxTibero Co., Ltd., Gyeonggi-do (KR)

(21) Appl. No.: 17/843,201

(22) Filed: Jun. 17, 2022

(30) Foreign Application Priority Data
Dec. 29, 2021 (KR) 10-2021-0190557

(51) Int. Cl. G06F 16/27; G06F 16/2458; G06F 16/21

(52) U.S. Cl. CPC G06F 16/27; G06F 16/2471; G06F 16/21

(57) ABSTRACT

Disclosed is a method for remotely managing a database performed by a gateway server including at least one processor. The method for remotely managing the database may include: receiving an access information registration request for using a second database server from a first database server; generating access information including first information for a first object usable by the first database server based on the access information registration request, the first object being positioned in the second database server; and transmitting a virtual object corresponding to the first object to the first database server based on the access information.

### CROSS-REFERENCE TO RELATED APPLICATIONS

This application claims priority to and the benefit of Korean Patent Application No. 10-2021-0190557 filed in the Korean Intellectual Property Office on Dec. 29, 2021, the entire contents of which are incorporated herein by reference.

### TECHNICAL FIELD

The present disclosure relates to a method for managing a database, and particularly, to a method for remotely managing a database.

### BACKGROUND ART

As technology for using a remote database server which exists on a network through a computing device, database link technology may exist. The database link technology may also be technology for using the remote database server which exists on the network in a database server accessed by a user. The user may use an object which exists in the remote database server through the database link technology. The object may be, for example, a table in which one or multiple columns are gathered to constitute one record. The user may use the object which exists in the remote database server through the computing device. For example, the user may insert a record or row data into a table type object. As another example, the user may delete the record or row data from the table type object.

However, the remote database server may be a database server which other users jointly use in addition to the user. Accordingly, when the user arbitrarily deletes or changes the record included in the object which exists in the remote database server, difficulties may occur when other users use the corresponding database server.

In the conventional database link technology, access information (e.g., an ID, a password, or an IP address) to the remote database server may be stored in the computing device or the database server used by the user. As a result, there may also be a problem in that the access information to the remote database server may be exposed.

### SUMMARY OF THE INVENTION

The present disclosure has been made in an effort to provide a method for using an object positioned in a remote database server.

However, technical objects of the present disclosure are not restricted to the technical object mentioned as above. Other unmentioned technical objects will be apparently appreciated by those skilled in the art by referencing to the following description.

An exemplary embodiment of the present disclosure provides a method for remotely managing a database performed by a gateway server including at least one processor. The method for remotely managing the database may include: receiving an access information registration request for using a second database server from a first database server; generating access information including first information for a first object usable by the first database server based on the access information registration request, the first object being positioned in the second database server; and transmitting a virtual object corresponding to the first object to the first database server based on the access information.

The access information may include second information for at least one first operation enabled to be performed by the first database server for the first object. Further, the method may further include: receiving a first query for using the first object included in the second database server from the first database server; extracting a target operation for the first object by parsing the first query; and determining whether the first query is to be executed by the second database server based on the first object, the target operation, and the access information.

The first query may include information on the virtual object corresponding to the first object.

The determining of whether the first query is to be executed by the second database server based on the first object, the target operation, and the access information may include determining whether the target operation is included in the at least one first operation based on the second information, and determining that the first query is not executed by the second database server when the target operation is not included in the at least one first operation.

The determining of whether the first query is to be executed by the second database server based on the first object, the target operation, and the access information may include determining whether the target operation is included in the at least one first operation based on the second information, and determining that the first query is executed by the second database server when the target operation is included in the at least one first operation.

The method may further include: receiving a result of performing the first query from the second database server; and delivering the result of performing the first query to the first database server.

The method may further include: re-writing the first query to include the first object corresponding to the virtual object based on information on the virtual object included in the first query when it is determined that the first query is executed by the second database server; and transmitting the re-written first query to the second database server so that the re-written first query is executed by the second database server.

The gateway server may include a reference object having a data structure of mapping the first object which exists in the second database server usable by the first database server and at least one first operation enabled to be performed by the first database server for the first object.

Disclosed is a gateway server for remotely managing a database, which may include: a communication unit receiving an access information registration request for accessing a second database server from a first database server; and a processor generating access information including first information for a first object usable by the first database server based on the access information registration request, the first object being positioned in the second database server, in which the communication unit may transmit a virtual object corresponding to the first object to the first database server based on the access information.

Disclosed is a computer program stored in a computer-readable storage medium in which when the computer program is executed by one or more processors, the computer program executes a method for remotely managing a database, and the method may include: receiving an access information registration request for accessing a second database server from a first database server; generating access information including first information for a first object usable by the first database server based on the access information registration request, the first object being positioned in the second database server; and transmitting a virtual object corresponding to the first object to the first database server based on the access information.

Technical solving means which can be obtained in the present disclosure are not limited to the aforementioned solving means and other unmentioned solving means will be clearly understood by those skilled in the art from the following description.

According to some exemplary embodiments of the present disclosure, a method for remotely managing a database which does not cause a problem for another use even though a user uses an object positioned in a remote database server can be provided.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the specific detailed matters. In other examples, known structures and apparatuses are illustrated in a block diagram form in order to facilitate description of the one or more aspects.

FIG. 1 illustrates an exemplary system for performing a method for remotely managing a database according to some exemplary embodiments of the present disclosure.

FIG. 2 is a flowchart for describing an example of a method for generating access information by a gateway server according to some exemplary embodiments of the present disclosure.

FIG. 3 illustrates an example for describing a method for determining whether a first query is to be executed in a second database server by a gateway server according to some exemplary embodiments of the present disclosure.

FIG. 4 is a flowchart for describing an example of a method for causing a first query to be executed in a second database server by a gateway server according to some exemplary embodiments of the present disclosure.

FIG. 5 is a flowchart for describing an example of a method for re-writing a first query by a gateway server according to some exemplary embodiments of the present disclosure.

FIG. 6 is a general schematic view of an exemplary computing environment in which exemplary embodiments of the present disclosure may be implemented.

### DETAILED DESCRIPTION

Various exemplary embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is determined that the detailed description makes the gist of the exemplary embodiment of the present disclosure unclear. Further, the accompanying drawings are only for easily understanding the exemplary embodiment disclosed in this specification and the technical spirit disclosed by this specification is not limited by the accompanying drawings.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present invention pertains. Terms defined in commonly used dictionaries should not be interpreted in an idealized or excessive sense unless expressly and specifically defined.

Moreover, the term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

In addition, the word “comprises” and/or “comprising” means that the corresponding feature and/or component is present, but it should be appreciated that presence or addition of one or more other features, components, and/or a group thereof is not excluded. Further, when not separately specified or it is not clear in terms of the context that a singular form is indicated, it should be construed that the singular form generally means “one or more” in this specification and the claims.

Further, the terms “information” and “data” used in the specification may also be often used to be exchanged with each other.

It should be understood that, when it is described that a component is “connected to” or “accesses” another component, the component may be directly connected to or access the other component or a third component may be present therebetween. In contrast, it should be understood that, when it is described that a component is “directly connected to” or “directly access” another component, no component is present between the component and another component.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention or a usual practice of a user or an operator.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

In the present disclosure a method for remotely managing a database may be performed by a gateway server. The gateway server may be a server providing an access between a first database server directly used by a user or accessed by the user and a second database server remotely positioned from the first database server. The gateway server may be a server that serves as a relay so that the user of the first database server uses an object included in the second database server. Alternatively, the gateway server may be a server that performs security or authentication so that the first database server uses an object positioned in the second database server. The object may mean a logical storage structure which exists in a database. As an example, the object may be a table in which one or multiple columns are gathered to constitute one record. As another example, the object may be a view which connects one or more tables, but does not store real data. As yet another example, the object may be an index for rapidly finding data in the table.

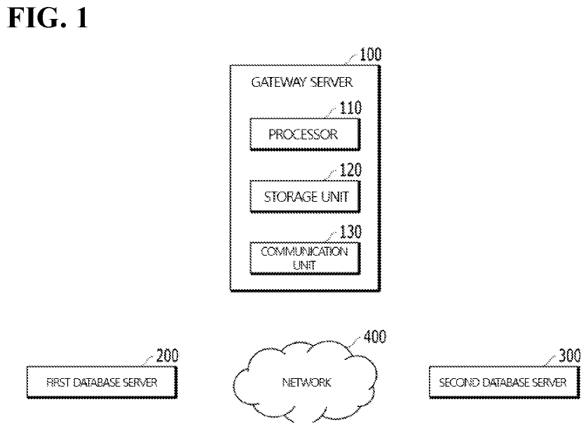

Hereinafter, a method for remotely managing a database performed by a gateway server according to the present disclosure will be described through FIGS. 1, 2, 3, 4, 5 and 6.

FIG. 1 illustrates an exemplary system for performing a method for remotely managing a database according to some exemplary embodiments of the present disclosure.

Referring to FIG. 1, a gateway server 100 may include a processor 110, a storage unit 120, and a communication unit 130. However, components described above are not required in implementing the gateway server 100 and the gateway server 100 may thus have components more or less than components listed above.

The gateway server 100 may include a predetermined type of computer system or computer device such as a microprocessor, a mainframe computer, a digital processor, a portable device, and a device controller.

The processor 110 may control an overall operation of the gateway server 100. The processor 110 processes a signal, data, information, and the like input or output through the components of the gateway server 100 or drives the application program stored in the memory to provide or process appropriate information or function.

The processor 110 may be constituted by one or more cores and may include processors for data analysis, which include a central processing unit (CPU), a general purpose graphics processing unit (GPGPU), a tensor processing unit (TPU), and the like of the gateway server 100.

In the present disclosure, the processor 110 may generate access information based on an access information registration request received from a first database server 200 through the communication unit 130. The access information may be information for using a first object positioned in a second database server 300 by the first database server 200. The object may be, for example, a table in which one or multiple columns are gathered to constitute one record.

Specifically, the access information may include first information on a first object usable by the first database server 200 and second information on at least one first operation which the first database server 200 for the first object may perform.

For example, a plurality of objects may be stored in the second database server 300. The processor 110 may generate first information indicating that the first database server 200 may use the first object among the plurality of objects based on the access information registration request received from the first database server 200 through the communication unit 130.

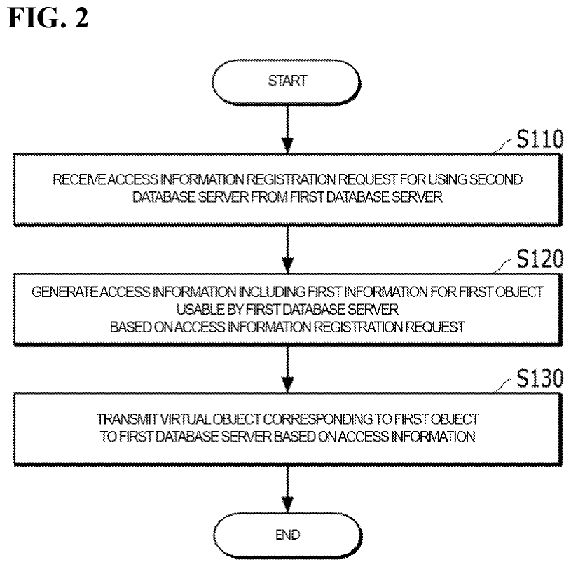

The processor 110 may generate second information for at least one first operation which the first database server 200 may perform for the first object. For example, at least one first operation as an operation related to a data manipulation language (DML) may be an operation such as SELECT, INSERT, UPDATE, or DELETE. The processor 110 may generate second information for at least one first operation which the first database server 200 may perform among SELECT, INSERT, UPDATE, or DELETE. According to an exemplary embodiment, at least one first operation as an operation related to a data definition language (DDL) may be an operation such as CREATE, ALTER, DROP, or TRUNCATE. At least one first operation as an operation related to a data control language (DCL) may be an operation such as GRANT, REVOKE, COMMIT, ROLLBACK, etc. Hereinafter, an example for the method for generating the access information by the processor 110 will be described through FIG. 2.

The storage unit 120 may include a memory and/or a persistent medium. The memory may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The storage unit 120 may include one or more memories including a buffer cache. Here, the memory as a primary storage device directly accessed by the processor 110, such as a random access memory (RAM) including a dynamic random access memory (DRAM), a static random access memory (SRAM), etc., may mean a volatile storage device in which stored information is momentarily erased when power is turned off, but is not limited thereto. The memory may be operated by the processor 110. The memory may include a buffer cache and data may be stored in a data block of the buffer cache. The data may be written in the storage unit 120 by a background process.

The storage unit 120 may store any type of information created or determined by the processor 110 or any type of information received by the communication unit 130. In the present disclosure, the storage unit 120 may store access information for using an object positioned in the second database server 300 by the first database server 200.

The communication unit 130 may include one or more modules which enable communication between the gateway server 100 and a communication system, between the gateway server 100 and the first database server 200, between the gateway server 100 and the second database server 300, or between the gateway server 100 and the network 400. The communication unit 130 may include at least one of a wired Internet module, and a wireless Internet module.

The gateway server 100 may further include a database management system (DBMS).

The DBMS as a program for permitting the gateway server 100 to perform operations including retrieval, insertion, modification, and/or deletion of required data may be implemented by the processor 110 in the memory.

The first database server 200 may include a predetermined type of computer system or computer device such as a microprocessor, a mainframe computer, a digital processor, a portable device, and a device controller. In the present disclosure, the first database server 200 may be a server used by the user. As an example, the first database server 200 may be the computing device or a local database server. As another example, the first database server 200 may be a database server which the user accesses through the computing device, etc.

The computing device may mean nodes in a database system having a mechanism for communication through a network 400. For example, the computing device may include a predetermined electronic device having connectivity with a personal computer (PC), a laptop computer, a workstation, a terminal, and/or the network. Further, the computing device may include a predetermined server implemented by at least one of agent, application programming interface (API), and plug-in.

According to some exemplary embodiments of the present disclosure, the gateway server 100 may also be a module included in the first database server 200. Alternatively, the first database server 200 may also include a computer program stored in a computer readable medium for implementing an operation performed by the gateway server 100 according to the present disclosure.

The second database server 300 may include a predetermined type of computer system or computer device such as a microprocessor, a mainframe computer, a digital processor, a portable device, and a device controller. In the present disclosure, the second database server 300 may be a server positioned remotely from the first database server 200. The second database server 300 may be a server at which at least one object the user of the first database server 200 intends to use is positioned.

The network 400 may be configured regardless of communication modes such as wired and wireless modes and constituted by various communication networks including a personal area network (PAN), a local area network (LAN), a wide area network (WAN), and the like. Further, the network may be known World Wide Web (WWW) and may adopt a wireless transmission technology used for short-distance communication, such as infrared data association (IrDA) or Bluetooth. The techniques described in this specification may also be used in other networks in addition to the aforementioned networks.

According to the above-described configuration, the gateway server 100 may generate the access information including the first information on the first object usable by the first database server 200 based on the access information registration request received from the first database server 200. The gateway server 100 may restrict the object usable by the first database server 200 based on the access information. For example, the gateway server 100 may generate access information so that the first database server 200 may use only the first object among the plurality of objects positioned in the second database server 300. Accordingly, the gateway server 100 may prevent the user of the first database server 200 from indiscreetly using the object positioned in the second database server 300. Further, the gateway server 100 may prevent the user of the first database server 200 from indiscreetly modifying or deleting the object positioned in the second database server 300.

Hereinafter, a method for remotely managing the database by the gateway server 100 will be described.

FIG. 2 is a flowchart for describing an example of a method for generating access information by a gateway server according to some exemplary embodiments of the present disclosure.

Referring to FIG. 2, the communication unit 130 of the gateway server 100 may receive an access information registration request for using the second database server 300 from the first database server 200 (S110). The access information registration request may be a request for accessing the gateway server 100 by the first database server 200. According to an exemplary embodiment, the access information registration request may include personal information of the user who uses the first database server 200 and an Internet protocol (IP) address of the first database server 200. The personal information may be, for example, an ID or a password. Alternatively, the access information registration request may also include information on a predetermined security level related to the first database server 200.

In the present disclosure, the access information registration request which the communication unit 130 receives from the first database server 200 may not be a request for using a specific database server. In the present disclosure, the access information registration request which the communication unit 130 receives from the first database server 200 may be a request for using not the specific database server but at least one database server. As an example, the user of the first database server 200 may not know at which database server the first object to be used is positioned. Accordingly, the user of the first database server 200 may transmit the access information registration request for using at least one database server to the gateway server 100 through the first database server 200.

The processor 110 may generate the access information including the first information on the first object usable by the first database server 200 based on the access information registration request (S120). Here, the first object may be an object positioned in the second database server 300. In other words, the processor 110 may generate access information including first information representing at least one object usable by the first database server 200 among a plurality of objects positioned in the second database server 300 based on the access information registration request.

According to some exemplary embodiments of the present disclosure, the access information may include second information for at least one first operation which the first database server 200 may perform for the first object.

Specifically, at least one first operation as an operation related to a data manipulation language (DML) may be an operation such as SELECT, INSERT, UPDATE, or DELETE. The processor 110 may generate second information for at least one first operation which the first database server 200 may perform among SELECT, INSERT, UPDATE, or DELETE.

For example, the processor 110 may determine that the first database server 200 may use the first object among the plurality of objects positioned in the second database server 300 and generate the first information. The processor 110 may generate second information for determining that the first database server 200 is capable of performing the SELECT operation for the first object. The processor 110 may generate second information for determining that the first database server 200 is not capable of performing the DELETE operation for the first object. According to an exemplary embodiment, the processor 110 may store the first information and the second information in the storage unit 120 in a list type.

According to some exemplary embodiments of the present disclosure, the gateway server 100 may include a reference object having a data structure that maps the first object which exists in the second database server 300 usable by the first database server 200 and at least one first operation which the first database server 200 may perform for the first object. Here, the reference object may be an object representing a location of the first object in the second database server 300. In other words, the gateway server 100 may not actually store the first object, but may store the reference object representing the location of the first object in the storage unit 120.

The communication unit 130 may transmit a virtual object corresponding to the first object to the first database server 200 based on the access information (S130). The virtual object may be a new object for defining the first object positioned in the second database server 300 to be used in the first database server 200. The virtual object may be a virtual object not including actual data. In other words, even though the processor 110 determines that the first database server 200 may use the first object, the processor 110 may not directly transmit the first object to the first database server 200. The reason is that when the first database server 200 directly uses the first object, a problem may occur for another user who uses the second database server 300. When the virtual object is received, the first database server 200 may display the virtual object to the user.

According to some exemplary embodiments of the present disclosure, the definition of the virtual object corresponding to the first object may be stored in the first database server 200 in the list type. The first database server 200 may define the virtual object regardless of existence of the first object which the virtual object refers to. In other words, the first database server 200 may define the virtual object even for an object which does not actually exist. The first database server 200 may not delete the definition of the virtual object even though the actual object to which the virtual object refers is deleted. When the first database server 200 transmits a query for using the first object to the gateway server 100, the first database server 200 may transmit information on the corresponding virtual object instead of the object registered in the gateway server 100. In other words, the query may include the information on the virtual object corresponding to the first object.

According to the above-described configuration, as the gateway server 100 receives the access information registration request for using the second database server 300 from the first database server 200, the gateway server 100 may generate access information including first information and second information. The gateway server 100 may transmit the virtual object corresponding to the first object to the first database server 200 based on the access information. Accordingly, the gateway server 100 may restrict an object usable by the user of the first database server 200, and as a result, security for the object positioned in the second database server 300 may be enhanced.

Access information for using the object positioned in the second database server 300 by the first database server 200 may be stored only in the gateway server 100. In other words, the access information related to the second database server 300 by the first database server 200 may not be stored in the first database server 200, but stored only in the gateway server 100. Accordingly, a situation may be prevented in which the access information for accessing the second database server 300 is exposed in the first database server.

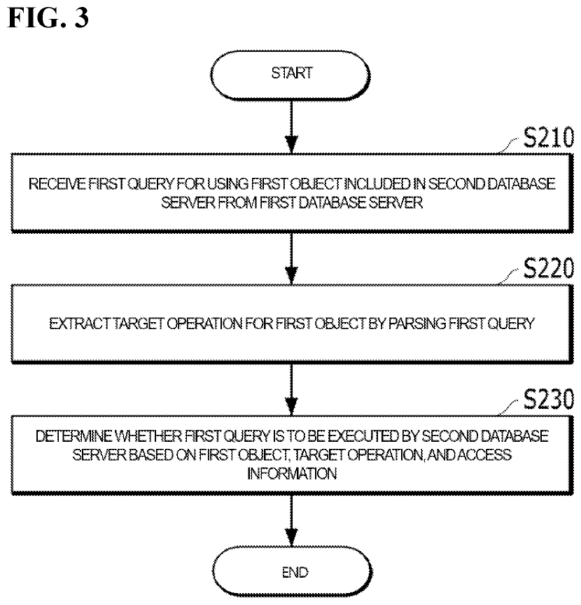

According to some exemplary embodiments of the present disclosure, the gateway server 100 may generate the access information to the first database server 200, and then receive the first query for using the first object included in the second database server 300 from the first database server 200. The gateway server 100 may determine whether the first query is to be executed in the second database server 300 based on the access information. Hereinafter, an example of the method for determining whether the first query is to be executed in the second database server 300 by the gateway server 100 according to the present disclosure will be described through FIG. 3.

FIG. 3 illustrates an example for describing a method for determining whether a first query is to be executed in a second database server by a gateway server according to some exemplary embodiments of the present disclosure.

Referring to FIG. 3, the communication unit 130 of the gateway server 100 may receive the first query for using the first object included in the second database server 300 from the first database server 200 (S210). For example, the communication unit 130 may receive a first query for selecting the first object. As another example, the communication unit 130 may receive a first query for deleting the first object.

The processor 110 may extract a target operation for the first object by parsing the first query (S220). The parsing may be generally an operation of checking a grammar of a query, whether there is an authority, checking whether there is a conventional query in a library cache, etc. In the present disclosure, the parsing may be appreciated as an operation of extracting an object which the first database server 200 intends to use and a target operation for the object through the first query. For example, the object which the first database server 200 intends to use may be the first object. When the first query is the query for selecting the first object, the target operation may be the SELECT operation for the first object. When the first query is the query for deleting the first object, the target operation may be the DELETE operation for the first object.

The processor 110 may determine whether the first query is to be executed in the second database server 300 based on the first object, the target operation and the access information (S230).

Specifically, the processor 110 may determine whether the target operation for the first object is an operation which may be performed by the first database server 200 based on second information.

For example, when it is determined that the target operation is included in at least one first operation based on the second information, the processor 110 may determine that the target operation is an operation which may be performed by the first database server 200. When it is determined that the target operation is the operation which may be performed by the first database server 200, the communication unit 130 transmits the first query to the second database server 300 to cause the first query to be executed by the second database server 300. When the second database server 300 executes the first query, the communication unit 130 may receive a result of performing the first query from the second database server 300. The communication unit 130 may deliver the result of performing the first query to the first database server 200.

As another example, when it is determined that the target operation is not included in at least one first operation based on the second information, the processor 110 may determine that the target operation is an operation which may not be performed by the first database server 200. When it is determined that the target operation is the operation which may not be performed by the first database server 200, the communication unit 130 may not transmit the first query to the second database server 300. According to an exemplary embodiment, when the target operation is the operation which may not be performed by the first database server 200, the processor 110 may return the first query. Here, a meaning of returning the first query may be appreciated as a meaning of not executing the first query. When the processor 110 returns the first query, information representing that a condition for executing the first query is not provided or information representing that the target operation included in the first query may not be performed by the first database server 200 may be generated, and transmitted to the first database server 200 through the communication unit 130.

According to the above-described configuration, the gateway server 100 may determine whether the first query is to be executed in the second database server 300 based on the first object, the target operation, and the access information when receiving the first query. When it is determined that the target operation is the operation which may be performed by the first database server 200, the gateway server 100 transmits the first query to the second database server 300 to cause the first query to be executed by the second database server 300. The gateway server 100 may receive the result of performing the first query from the second database server 300 and deliver the received result to the first database server 200. As a result, the user of the first database server 200 may recognize that the operation for the first object or the virtual object corresponding to the first object is performed only in the first database server 200. Accordingly, existence of the gateway server 100 and the second database server 300 may not be exposed to the user, and furthermore, the user may not also recognize in which database server the first object exists. In this case, the security for the plurality of objects positioned in the second database server 300 may be enhanced.

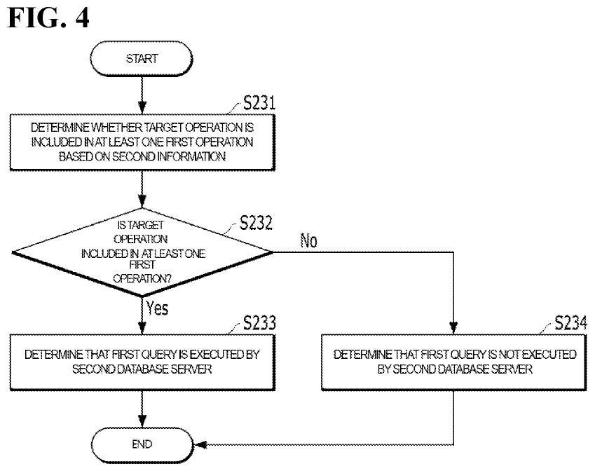

According to some exemplary embodiments of the present disclosure, the gateway server 100 may determine that the first query is executed by the second database server 300 based on whether the target operation being included in at least one first operation. Hereinafter, an example of a method in which the gateway server 100 causes the first query to be executed by the second database server 300 according to the present disclosure will be described through FIG. 4.

FIG. 4 is a flowchart for describing an example of a method for causing a first query to be executed in a second database server by a gateway server according to some exemplary embodiments of the present disclosure.

Referring to FIG. 4, the processor 110 of the gateway server 100 may determine whether the target operation is included in at least one first operation based on the second information (S231).

When the target operation is included in at least one first operation (S232, Yes), the processor 110 may determine that the first query is executed in the second database server 300 (S233). When it is determined that the first query is executed, the communication unit 130 transmits the first query to the second database server 300 to cause the first query to be executed by the second database server 300. When the second database server 300 executes the first query, the communication unit 130 may receive the result of performing the first query from the second database server 300. The communication unit 130 may deliver the result of performing the first query to the first database server 200.

When the target operation is not included in at least one first operation (S232, No), the processor 110 may determine that the first query is not executed in the second database server 300. When it is determined that the first query is not executed, the communication unit 130 may not transmit the first query to the second database server 300. According to an exemplary embodiment, when it is determined that the target operation is the operation which may not be performed by the first database server 200, the processor 110 may return the first query.

According to the above-described configuration, the gateway server 100 may transmit or not transmit the first query to the second database server 300 based on whether the target operation being included in at least one first operation. If the gateway server 100 transmits the first query to the second database server 300 without determining whether the target operation is included in at least one first operation, the second database server 300 may also execute the first query prepared by a user having no authority. In this case, at least one object may be modified or deleted by the user having no authority. Accordingly, the gateway server 100 may transmit or not transmit the first query to the second database server 300 based on whether the target operation being included in at least one first operation.

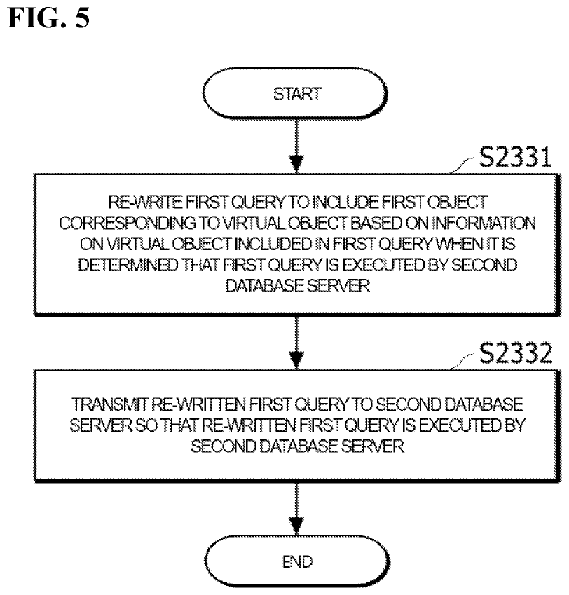

According to some exemplary embodiments of the present disclosure, the gateway server 100 may re-write the first query. As an example, the user of the first database server 200 may generate the first query by using the first object. Since the first object delivered to the first database server 200 in advance is actually the virtual object, the first query may be generated based on the virtual object. As a result, the first query may be a query generated by using the virtual object corresponding to the first object. On the contrary, the first object positioned in the second database server 300 may be a real object other than the virtual object. Accordingly, the gateway server 100 may re-write the first query so as for the second database server 300 to execute the first query. However, although not illustrated thereto, the first query may also include information on the first object corresponding to the virtual object. In other words, the first query may also be a query generated based on the first object corresponding to the virtual object. Hereinafter, an example of a method in which the gateway server 100 re-writes the first query according to the present disclosure will be described through FIG. 5.

FIG. 5 is a flowchart for describing an example of a method for re-writing a first query by a gateway server according to some exemplary embodiments of the present disclosure.

Referring to FIG. 5, the processor 110 of the gateway server 100 may determine that the first query is executed by the second database server 300. The processor 110 may re-write the first query to include the first object corresponding to the virtual object based on the information on the virtual object included in the first query (S2331). Here, a meaning of re-writing the query may be a meaning of modifying or re-preparing the first query to be executed with higher performance in spite of generating the same result.

Specifically, the first query may be a query generated by using the virtual object corresponding to the first object. On the contrary, the first object positioned in the second database server 300 may be a real object other than the virtual object. Accordingly, the gateway server 100 may re-write the first query so as for the second database server 300 to execute the first query and make the first object be included in the first query.

The communication unit 130 may transmit the re-written first query to the second database server 300 so as for the second database server 300 to execute the re-written first query (S2332). As a result, the second database server 300 may perform the re-written first query and deliver a result of performing the re-written first query to the gateway server 100. The gateway server 100 may deliver the result received from the second database server 300 to the first database server 200.

According to the above-described configuration, the gateway server 100 may re-write the first query received from the first database server 200. Accordingly, even though the user generates the first query by using the virtual object corresponding to the first object, the first query may be executed by the second database server 300. As a result, the user may conveniently generate the query without recognizing whether a currently used object is the virtual object or the real object.

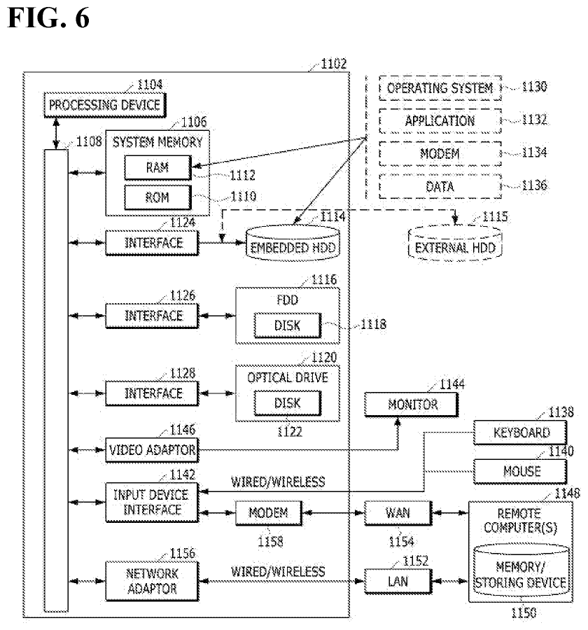

FIG. 6 is a general schematic view of an exemplary computing environment in which exemplary embodiments of the present disclosure may be implemented.

The present disclosure has generally been described above in association with a computer executable command which may be executed on one or more computers, but it will be well appreciated by those skilled in the art that the present disclosure can be implemented through a combination with other program modules and/or as a combination of hardware and software.

In general, the module in the present specification includes a routine, a procedure, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. The computer includes, as a computer accessible medium, volatile and non-volatile media, transitory and non-transitory media, and mobile and non-mobile media. As a non-limiting example, the computer readable media may include both computer readable storage media and computer readable transmission media.

The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an internal hard disk drive (HDD) 1114 (for example, EIDE and SATA)—the internal hard disk drive 1114 may also be configured for an external purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD). The hard disk drive 1114, the magnetic disk drive 1116, and the optical disk drive 1120 may be connected to the system bus 1108 by a hard disk drive interface 1124, a magnetic disk drive interface 1126, and an optical disk drive interface 1128, respectively. An interface 1124 for implementing an external drive includes, for example, at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable instructions for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a server computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158, is connected to a communication server on the WAN 1154, or has other means that configure communication through the WAN 1154 such as the Internet, etc. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term “manufactured article” includes computer programs or media which are accessible by a predetermined computer-readable device. For example, a computer readable storage media includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. The term “machine-readable media” includes a wireless channel and various other media that can store, possess, and/or transfer instruction(s) and/or data, but is not limited thereto.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for remotely managing a database performed by a gateway server including at least one processor, the method comprising:
receiving an access information registration request for using a second database server from a first database server;
generating access information including first information for a first object usable by the first database server based on the access information registration request, the first object being positioned in the second database server; and
transmitting a virtual object corresponding to the first object to the first database server based on the access information.

2. The method of claim 1, wherein the access information includes second information for at least one first operation enabled to be performed by the first database server for the first object.

3. The method of claim 2, further comprising:
receiving a first query for using the first object included in the second database server from the first database server;
extracting a target operation for the first object by parsing the first query; and
determining whether the first query is to be executed by the second database server based on the first object, the target operation, and the access information.

4. The method of claim 3, wherein the first query includes information on the virtual object corresponding to the first object.

5. The method of claim 3, wherein the determining whether the first query is to be executed by the second database server based on the first object, the target operation, and the access information includes
determining whether the target operation is included in the at least one first operation based on the second information, and
determining that the first query is not executed by the second database server when the target operation is not included in the at least one first operation.

6. The method of claim 3, wherein the determining whether the first query is to be executed by the second database server based on the first object, the target operation, and the access information includes
determining whether the target operation is included in the at least one first operation based on the second information, and
determining that the first query is executed by the second database server when the target operation is included in the at least one first operation.

7. The method of claim 6, further comprising:
receiving a result of performing the first query from the second database server; and
delivering the result of performing the first query to the first database server.

8. The method of claim 3, further comprising:
re-writing the first query to include the first object corresponding to the virtual object based on information on the virtual object included in the first query when it is determined that the first query is executed by the second database server; and
transmitting the re-written first query to the second database server so that the re-written first query is executed by the second database server.

9. The method of claim 1, wherein the gateway server includes a reference object having a data structure of mapping the first object which exists in the second database server usable by the first database server and at least one first operation enabled to be performed by the first database server for the first object.

10. A gateway server for remotely managing a database, comprising:
a communication unit receiving an access information registration request for accessing a second database server from a first database server; and
a processor generating access information including first information for a first object usable by the first database server based on the access information registration request, the first object being positioned in the second database server,
wherein the communication unit transmits a virtual object corresponding to the first object to the first database server based on the access information.

11. A non-transitory computer-readable storage medium including computer program, wherein when the computer program is executed by one or more processors, the computer program executes a method for remotely managing a database, the method comprising:
receiving an access information registration request for accessing a second database server from a first database server;
generating access information including first information for a first object usable by the first database server based on the access information registration request, the first object being positioned in the second database server; and
transmitting a virtual object corresponding to the first object to the first database server based on the access information.
